(19) United States
(12) Patent Application Publication
(10) Pub. No.: US 2009/0327934 A1
(43) Pub. Date: Dec. 31, 2009

(54) System and method for a presentation component

(75) Inventors: Vincent Serpico, Phoenix, AZ (US); Donald Pierson, Phoenix, AZ (US); Kieran Richardson, Gilbert, AZ (US)

Correspondence Address: QUARLES & BRADY LLP, RENAISSANCE ONE, TWO NORTH CENTRAL AVENUE, PHOENIX, AZ, 85004-2391, US

(73) Assignee: FLYPAPER STUDIO, INC., Phoenix, AZ (US)

(21) Appl. No.: 12/147,164

(22) Filed: Jun. 26, 2008

(51) Int. Cl. G06F 3/048

(52) U.S. Cl. 715/764

(57) ABSTRACT

In a display component, a component application having an attribute is provided. The component application is configured to communicate with an external system. In one embodiment the component application receives a communication from the external system to modify the value of the attribute. A value of the attribute of the display component is modified to define a logical relationship between a plurality of presentation elements. The presentation elements are operated and displayed by the external system. A user input is received via a user interface of the component application. The logical relationship between the presentation elements is triggered in response to the user input. In one embodiment, triggering the logical relationship includes defining an alternate path through a presentation. In another embodiment, an edit mode user interface for modifying a value of an internal display component attribute is provided.

### CROSS-REFERENCE TO RELATED APPLICATIONS

The present application is related to co-pending U.S. application Ser. No. (Pending), entitled “System and Method for an Interactive Presentation System,” Attorney Docket No. 116857.00008, filed concurrently herewith by Vincent Serpico et al.

### FIELD OF THE INVENTION

The present invention relates in general to an electronic presentation display component and, more particularly, to a system and method of creating, modifying and viewing the presentation display component.

### BACKGROUND OF THE INVENTION

Many businesses, researchers, and other entities have a regular need to collect information into a presentation and display that presentation to viewers. The presentations are designed to both communicate facts and ideas and to maintain a viewer's attention. To meet those goals, presentation software applications have been developed to assist a user in quickly and easily preparing presentations. Generally, the software applications allow for the integration of both text and other visual elements to create presentations that contain the necessary information and are also visually engaging. The addition of simple multimedia such as graphic and sound elements serve to both maintain a viewer's attention and also to facilitate the communication of complex ideas.

Although the addition of simple multimedia elements such as images, movies, and sound to a presentation can facilitate the communication of complex ideas, the addition of more sophisticated display elements can further facilitate the communication of complex ideas. Presentations that depict complex data, for example, may be enhanced by display elements that depict graphs and allow for user interaction with those graphs. By manipulating the data displayed by the graph, the viewer can develop a more robust understanding of the data and the effect that changes to one or more inputs may have on the output. Similarly, a presentation relating to complex electronic circuitry may include display elements that allow the viewer to zoom in on and see the operation of different parts of the circuit. All manner of presentation may be improved by the addition of display elements that allow for user interaction, incorporate sophisticated functionality and provide compelling and unique representations of the information contained within the presentation.

Generally, existing presentation software creation tools provide a simple interface and allow a user to quickly insert content into a presentation. Using the software, a user places text, simple shapes, and multimedia such as images, video, or sound into one or more slides of the presentation. During the editing process, the user adjusts the content of each slide and their order within the presentation. After the presentation is complete, the presentation file is saved and transmitted to another user or party that wishes to view the presentation.

To speed up the presentation development process, some tools allow a user to import pre-made content into the presentation. The pre-made content includes graphics, images, and other multimedia content that a user can incorporate into a presentation to minimize its development time. Without access to the pre-made content, a user must prepare each and every element of the presentation from scratch, greatly increasing its development time.

The pre-made content generally includes simple shapes and graphics known as clip-art and has no additional functionality. The content is designed to stand alone and does not interact with the other elements of the presentation or the viewer. In the case of pre-made multimedia content, the viewer is restricted to viewing images and playing, pausing or rewinding video or audio content.

Although sophisticated software tools exist for the preparation of presentations that incorporate elaborate display elements that are capable of interacting with a viewer, the tools are difficult to use and often require a basic understanding of computer programming. As a result, the user cannot drag and drop pre-made content into a presentation, modify the display attributes of the content and configure the content to interact with other elements of the presentation and the viewer. Instead, the user must import the pre-made content and modify the computer code that drives the content to provide the desired interactivity and/or functionality.

A need exists for a presentation display component that is easier to develop, modify and incorporate into a presentation and more effective in conveying information to users.

### SUMMARY OF THE INVENTION

In one embodiment, the present invention is a computer-implemented method of providing a display component comprising providing a component application having an attribute. The component application is configured to communicate with an external system. The method includes modifying a value of the attribute of the display component to define a logical relationship between a plurality of presentation elements. The presentation elements are operated and displayed by the external system. The method includes receiving a user input via a user interface of the component application and triggering the logical relationship in response to the user input.

In another embodiment, the present invention is a computer-implemented method of providing a display component comprising providing a component application having an attribute, modifying a value of the attribute of the display component to define a logical relationship between a plurality of presentation elements. The presentation elements are operated and displayed by an external system. The method includes receiving a user input via a user interface of the component application, and triggering the logical relationship between the plurality of presentation elements in response to the user input.

In another embodiment, the present invention is a computer program product usable with a programmable computer processor having a computer readable program code embodied therein comprising computer readable program code which provides a component application having an attribute. The component application is configured to communicate with an external system. The product includes computer readable program code which modifies a value of the attribute of the display component to define a logical relationship between a plurality of presentation elements. The presentation elements are operated and displayed by the external system. The product includes computer readable program code which receives a user input via a user interface of the component application, and computer readable program code which triggers the logical relationship in response to the user input.

In another embodiment, the present invention is a computer system for providing a display component comprising means for providing a component application having an attribute. The component application is configured to communicate with an external system. The system includes means for modifying a value of the attribute of the display component to define a logical relationship between a plurality of presentation elements. The presentation elements are operated and displayed by the external system. The system includes means for receiving a user input via a user interface of the component application and means for triggering the logical relationship in response to the user input.

### BRIEF DESCRIPTION OF THE DRAWINGS

FIG. 1 illustrates a process of using a presentation software system to create a presentation;

FIG. 2 illustrates a computer system and network for operating the presentation software system;

FIG. 3 illustrates several components displayed on a screen;

FIG. 4 illustrates the contents of a component;

FIG. 5 illustrates a user interface of a software application for developing a component attribute file;

FIGS. 6A and 6B illustrate the output of a component running under normal conditions and under component edit mode;

FIG. 7 illustrates a presentation software system;

FIG. 8 illustrates a user interface of a software application for developing a presentation;

FIG. 9 illustrates a user interface of a software application for developing a presentation including a library of templates;

FIG. 10 illustrates a community system for distributing contents of a presentation; and

FIG. 11 is a flowchart of using the presentation system.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The goal of a presentation is to provide an engaging and informative experience that maintains a viewer's attention while communicating key ideas, facts and concepts. Although many commercial organizations exist for preparing high-quality professional presentations, their work product is often expensive and requires a significant amount of time to prepare. Also, because the use of a third-party organization increases development time, it can significantly delay the creation of modifications and updates for the presentation.

In response to a demand for less expensive and easily prepared and modified presentations, several software products such as Microsoft's PowerPoint have been developed. Although easy to use, these products offer only a limited collection of design tools, graphic design elements, and multimedia functionality. Accordingly, presentations created with these tools tend to lack the professional look and feel of presentations created with the use of more sophisticated design software applications. Also, because the tools are relatively ubiquitous, their simplistic design capability results in presentations that are all alike and readily recognized as having been generated by such a tool. For users hoping to create vibrant, distinctive, and interesting presentations, these tools fail to provide an adequate design environment.

Existing presentation tools similarly lack mechanisms for preparing presentations that are dynamic and responsive to viewer input. Because the tools create linear presentations, a viewer must step through the presentation in a pre-determined sequence as specified by the author. As a result, it is difficult for the user to ‘browse’ the contents of the presentation. If, for example, the viewer is already conversant with the material contained in one portion of the presentation, the viewer is generally unable to skip ahead. Alternatively, if the viewer wishes to review material or to spend time exploring another section of the presentation, the viewer cannot easily jump to different sections of the presentation.

In contrast, dynamic presentations tailor the presentation content in response to viewer input. If, for example, a viewer expresses an interest in viewing only the technical detail associated with a sales presentation, the presentation is altered to reflect that preference. However, if a viewer expresses a preference for financial information over technical information, the presentation software responds to that input and displays a presentation that is focused primarily on financial data.

Finally, although the existing systems allow for the insertion of pictures or video into a presentation, they lack the capability to incorporate more sophisticated and interactive graphic components. A user is generally limited to viewing images, and playing or pausing video or sound. Beyond those basic functions, the display elements of a presentation have no capability to interact or respond to user input.

More sophisticated software packages exist for the preparation of presentations, however they present their own difficulties. Graphic and multimedia design tools such as Adobe's Flash, Photoshop, or Illustrator, and Microsoft's Expression Studio allow for the creation of rich, viewer-interactive presentations. However, the applications require a sophisticated user with at least a basic understanding of computer programming.

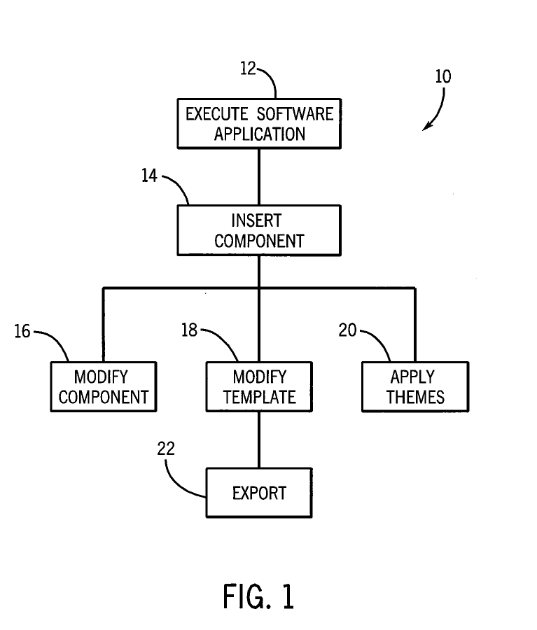

With the present system, a user prepares a presentation in accordance with the method shown in FIG. 1. The presentation software application is installed on a desktop computer system that is accessible by the user. The user executes the presentation software application in step 12. Upon executing the software, the user is presented with a graphical user interface (GUI) that provides tools allowing the user to manipulate and modify the presentation's display elements, import additional content, alter the relationships of the various components of the presentation, and, ultimately, export the presentation for viewing.

Upon initializing the software, a new presentation screen is displayed. At this point the user can continue editing the new presentation or open an existing presentation for editing. By default, a new presentation contains a single template or presentation slide, into which content is inserted. The presentation's templates act as containers for the components and the other content that makes-up the presentation. Each template contains different content and displays a different section of the presentation. Throughout the presentation editing process, additional templates with differing content are added to the presentation.

The user imports a component into the presentation and places it within a template in step 14. The component generally comprises a computer program and includes code that displays content, interacts with other components, may control the content flow of the presentation, and communicates with other systems to retrieve data. The component also includes text, graphics, or other multimedia output that is displayed by the component within the template. Many components may be added to a single template. As the user continues to build the presentation, additional templates are added to the presentation and additional components are placed within those templates. In addition to adding components to the templates of the presentation, the user adds additional display elements such as buttons, shapes, graphics, video, pictures, and sound.

The user modifies the templates and their contents in steps 16 and 18. In step 16, the user modifies the content of one or more components. The general appearance of a component is modified by adjusting its dimensions, orientation, placement, depth, and opacity within the template of the presentation. The user also modifies the internal display or output of the component. For example, if the component is configured to display an image and includes an interface for modifying that image, the user selects a replacement image to be loaded into the component for display. Similar modification may be made to components that display video, play audio, or output other multimedia. Beyond the attributes of size, orientation, placement, depth and opacity, the ability to modify the specific attributes of a component is largely governed by the component itself.

The components are also adjusted to alter their inter-relationships or logical relationships by configuring one component to perform an action on another component or display element. For example, a component is configured to cause another component or display element to disappear. The components are also configured to perform actions on the templates themselves, for example by changing the currently displayed template within a presentation.

In step 18, the user modifies the templates or presentation slides by adjusting their appearance and other attributes. The user modifies the look of a template by altering the background images or audio associated with the template. The user also adjusts the display timing characteristics for each template by specifying a display duration. In addition to preparing each template for the presentation, pre-made templates are added to the presentation. Pre-made templates include one or more components and display elements that are already included within the template. Background images or audio are also defined within a pre-made template.

In step 20, the user modifies the entire presentation by applying a theme. A theme includes graphics, text, components or display elements that are inserted into every template of the presentation. For example, a theme includes a corporate graphic and a copyright notice that a user wishes to apply to all templates contained within a presentation. By applying that theme in step 20, the user ensures that the logo and the copyright notice appear upon every template in the presentation.

In step 22, after the user has completed the presentation editing process (steps 16, 18, and 20), the final presentation is exported so it can be transmitted to a viewer. The exported presentation includes one or more digital files. In step 22, the presentation may be exported as an Adobe Flash .swf file, executable file, video (including .wmv, .mpeg, .flv, or .qt formats) that is transmitted to viewers via the Internet or other communication medium.

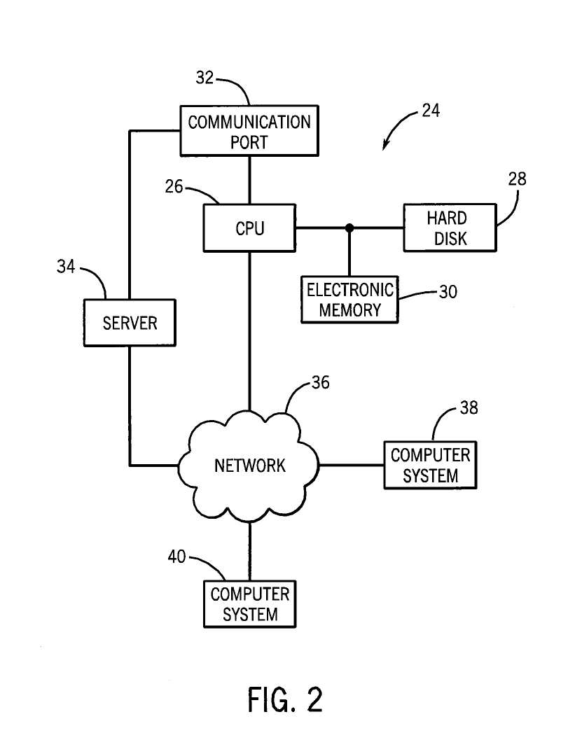

FIG. 2 illustrates a simplified computer system 24 for executing the presentation software system. Computer system 24 is a general purpose computer including a central processing unit or microprocessor 26, mass storage device or hard disk 28, electronic memory 30, and communication port 32. Communication port 32 represents a modem, high-speed Ethernet link, or other electronic connection mechanism to transmit and receive input/output (I/O) data with respect to other computer systems.

Computer 24 is shown connected to server 34 by way of communication port 32, which in turn is connected to communication network 36. Server 34 includes mass storage devices, operating system code, and communication links for interfacing with communication network 36. Using communication network 36, server 34 provides a user interface for transmitting and receiving data. Communication network 36 can be a local and secure communication network such as an Ethernet network, global secure network, or an open architecture network such as the Internet. Computer systems 38 and 40 can be configured similarly to computer 24 or may be dedicated and secure data terminals. Computers 38 and 40 are also connected to communication network 36. Computers 24, 38, and 40 transmit and receive information and data over communication network 36.

When used as a standalone unit, computer 24 is located in any convenient location. When used as part of a computer network, computers 24, 38, and 40 can be physically located in any location with access to a modem or communication link to network 36. For example, computer 24 can be located in a service provider's or administrator's main office. In one embodiment, computer 38 can be located in one department of a company, e.g., the sales office. Computer 40 can be located in another department of the company, e.g., the marketing department. Alternatively, the computers can be mobile and follow the users to any convenient location, e.g., remote offices, customer locations, hotel rooms, residences, vehicles, public places, or other locales with or without electronic access to communication network 36.

Each computer runs application software and computer programs, which can be used to display user interface screens, execute the system functionality, and provide the features of the presentation software system as described hereinafter. In one embodiment, the screens and functionality come from locally-running application software, i.e., the presentation software system runs directly on one of the computer systems. Alternatively, the screens and functions are provided remotely from one or more websites or other remote interfaces communicated via the Internet. In this case, the local computer is a portal to the presentation software system running on a remote computer. The websites are generally restricted access and require passwords or other authorization for accessibility. Communications through the website may be encrypted using secure encryption algorithms. Alternatively, the screens are accessible only on the secure private network, such as a Virtual Private Network (VPN), with proper authorization.

The software is originally provided on computer readable media, such as compact disks (CDs), magnetic tape, flash memory drives, or other mass storage medium. Alternatively, the software is downloaded from remote storage systems such as a host or vendor website. The software is installed onto the computer system hard drive 28 and/or electronic memory 30, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilations of executable code which perform the functions of the presentation software system. The user interacts with the software via keyboard, mouse, voice recognition, and other user interface devices connected to the computer system.

The software stores information and data related to presentation software system in a database or file structure located on any one of, or combination of, hard drives 28 or electronic memories 30 of computers 24, 38, 40, and/or server 34. More generally, the information used in the system can be stored on any mass storage device accessible to computers 24, 38, 40, and/or server 36. The mass storage device for storing the system may be part of a distributed computer system.

In the case of Internet-based websites, the interface screens are implemented as one or more webpages for receiving, viewing, and transmitting information related to the presentation software system. A host service provider may set up and administer the website from computer 24 or server 34 located in the host service provider's home office. The user or viewer accesses the webpages from computers 38 and 40 via communication network 36.

For the present example, the presentation software system will be developed as one software application for all end users, although the system could be implemented in multiple software modules or applications.

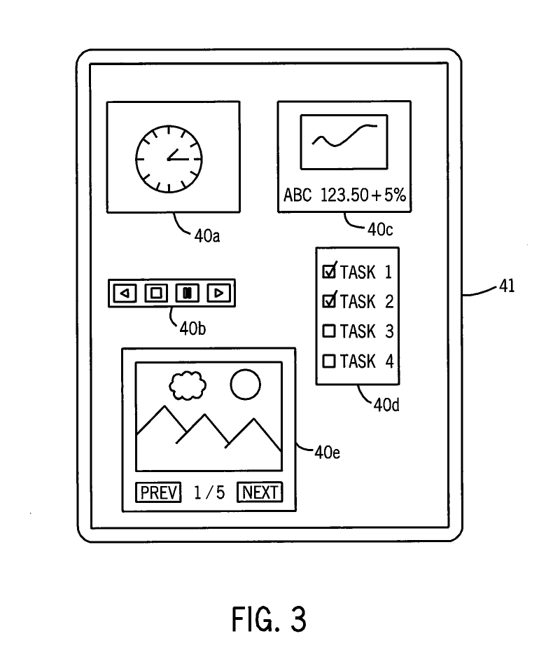

Turning to FIG. 3, a plurality of display components 40 (including components 40a-40e) are shown on screen 41. Components 40 include clock 40a, music player 40b, stock ticker 40c, checklist 40d, and image viewer 40e. Components 40a-40e comprise self-contained display elements that generate audio and visual output, include advanced user interfaces, and are added to presentations or other output of an external system. In FIG. 3, each component 40 is inserted into a presentation and then displayed via screen 41. After they are imported, components 40 are moved and adjusted to create the presentation. Many components 40, along with other display elements are added to one or more of a presentation's templates or slides. Within their own display window, each component 40 generates output and provides a user interface. By interacting with the interface, a user can interact with component 40, control the flow of the presentation, and trigger the logical relationships between presentation elements. Accordingly, although each component 40 generally comprises a stand-alone application generating its own output and providing its own user interface, by combining a plurality of components 40 and other display elements within a presentation or the output of an external system, a presentation with enhanced user-interaction is created.

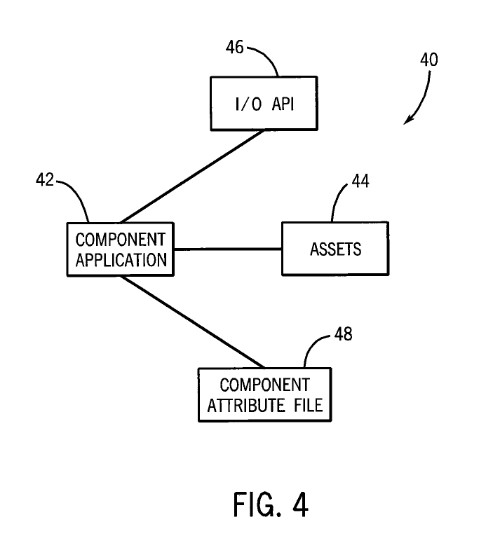

Turning to FIG. 4, the contents of component 40 are depicted. Component 40 includes pre-made content and functionality that allows it to interact with other components 40 of a presentation and the presentation itself. A user imports one or more components 40 into a presentation, changes their display attributes and defines relationships between each component 40 and template of the presentation. Component 40 responds to user input and interacts with an external display or presentation editing system. Component 40 includes component application 42, assets 44, input-output application programming interface (IO API) 46, and component attribute file 48. The different parts of component 40 are packaged in one or more files that are accessible by computer 24.

Component application 42 manipulates data, outputs sound, graphics, and text and includes additional functionality. Component application 42 may be prepared using Adobe Flash, Microsoft expression programming languages and software development tools, or ActionScript languages including ActionScript 3.0. Component application 42 may include a music or video player than can read a digital file or file stream containing multimedia data and then play the output to a viewer. Alternatively, component application 42 includes computer code that connects to a remote server, retrieves data from that server and then outputs it. Other example component applications 42 include calculators, graphic sketch tools, alarm clocks, notepads, pagers, smiley faces, simple shapes, text boxes, and combinations thereof. Component application 42 also includes graphic and audio effects that are applied to the component 40's content. In some cases, component application 42 does not output any visual data. If so, component 40 is added to a template, but is not displayed when the presentation is exported or viewed. If component application 42 outputs visual data, it operates within a defined area having a perimeter. The perimeter defines the dimensions of component application 42 and, thereby, component 40 and vice versa.

Component application 42 has several modes of operation depending upon its current operating environment. The current operating environment is stored within a system state variable made available to component 40. Environments for component application 42 include a run-time environment and an edit environment. Component 40 is placed in an edit environment while its content is edited, or while the presentation containing the component is edited. After the presentation is exported and while it is viewed, component 40 is placed in a run-time environment. Depending upon the current environment, component 40 displays different content and outputs alternative multimedia. For example, a component 40 that includes sound effects is muted while in an edit environment to prevent repetition of the sound effects while it or a presentation is edited. However, when the component is placed in a run-time environment the component plays the sound effects. For some components 40, component application 42 operates in the same manner whether the component is operating under edit-mode, run-time mode, or another mode. A developer of component 40 and component application 42 includes different functionality based on the component 40's current operating environment.

Component application 42 has several attributes that control its functionality and output. Any variable used by or contained within component application 42 can be defined as an attribute. The attributes include variables that store strings of text, counters that control the repetition of a particular action, variables that contain a link to a data file, or variables that identify a particular image to display. Although any variable created or used by component application 42 may be designated as an attribute, the attributes generally include those variables that affect component application 42's output, internal logic, or input. Furthermore, attributes may define a logical relationship between one component 40 and another component 40. For example, an attribute may define the flow of the templates of the presentation, or an action to be taken by another component 40 given a particular viewer input.

The attributes are assigned default values, but may be updated by an external system such as a presentation editing system that includes an interface for modifying the attributes of component 40. To update an attribute, an external system transmits an update command to component application 42. The command includes the name of the attribute and its new value. Upon receiving the command, component application 42 updates the locally stored attribute and responds accordingly. The response includes retrieving the new attribute value and modifying the output, internal logic, or input of component application 42 based upon that new value.

As an example, a component application 42 includes an attribute entitled ‘title_text’ that defines a string of text displayed by component application 42. Component application 42 stores the ‘title_text’ attribute and its value in an internal listing of its own attributes. ‘title_text’ has an initial default value of ‘NO TITLE.’ When component application 42 is initialized, it retrieves the current (or default) value of ‘title_text’ and displays it. Upon receiving a message from the external editing system instructing it to update ‘title_text’ to ‘PRESENTATION ONE’, component application 42 modifies the value of the locally stored attribute ‘title_text’, retrieves the new updated attribute value, and outputs ‘PRESENTATION ONE’ as the new title. Additional example attributes include the color of one or more shapes displayed by component application 42, text entries contained in a table, a number from 0-100 defining opacity, a Boolean value to select whether component application 42 is muted, or an entry specifying which of three graphic options or animations to display.

A listing of attributes and other data relating to component 40 is stored in component attribute file 48. The listing includes a name, default value, and a preferred edit method for each attribute in addition to information relating to component 40 itself, including a name, description, author, default placement values, link to a default icon, link to component application 42, and an identification number or string. The preferred edit method for an attribute describes a preferred user interface for modifying the value of the attribute. For example, if the attribute includes a color, a color picker interface is the preferred edit method. However, if the attribute includes text, a text box is the preferred edit method. Having defined the attributes and a preferred edit method in component attribute file 48, an external editor accesses component attribute file 48 and provides the preferred user interface for altering those attributes and thereby one or more of component 40's display characteristics.

By providing a listing of available attributes and allowing an external editor to modify the values of those attributes, the development time for component 40 can be minimized. If such a listing is not provided, each individual component 40 provides its own user interface for allowing a user to modify each of its attributes. The development of such an interface takes time, adds complexity to component 40 and increases the file size of component 40.

In an alternative embodiment, component attribute file 48 includes a listing of one or more methods or functions made available by component 40. The listing includes a name or identifier and arguments for each function, and the data types of each argument. For example, a component 40 includes a function that causes the component to display one of three animations. The function for playing the animation is called ‘play_animation’ and it requires a single argument, ‘animation’, which is a number specifying which of the three available animations to play. After receiving a command to execute the ‘play_animation’ function, component 40 determines the value of the associated argument ‘animation’ and plays the corresponding animation. In this example, component attribute file 48 includes the name of the function, ‘play_animation’, the argument associated with the function, ‘animation’, and its data type of integer. Having defined a listing of available functions in component attribute file 48, an external presentation editing system configures other components 40 or display elements to communicate with component 40 and cause it to execute one or more of its available functions.

The following example describes a component attribute file 48 for a component 40 that displays colored text having a particular font. The component attribute file 48 for the component includes the following listing:

TABLE 1
Example Component Attribute File 48

| Attribute Name | Default Value | Edit Method |
|---|---|---|
| text | ENTER TEXT HERE | textbox |
| text_font | Times_New_Roman | select_box |
| text_color | #336699 | color_picker |

An external editor retrieves the listing of attributes from the component attribute file 48 for the component as depicted in Table 1 and, based upon the listing contained therein, provides a user interface for a user to adjust the component 40's attributes. Referring to the component attribute file 48 shown in Table 1, the user interface includes a textbox into which a user types a replacement text string for the component, a select box for picking a font from a listing of available fonts, and a color picker for selecting the color for the text displayed by the component. Accordingly, by providing the listing of attributes for example component 40 and specifying an appropriate edit method, the component developer does not need to prepare an additional user interface for modifying those attributes. Instead, the external editor retrieves the listing of attributes stored within component attribute file 48, provides a user interface based upon that listing, and, after the user has modified the values via the interface, communicates the new attribute values to component 40.

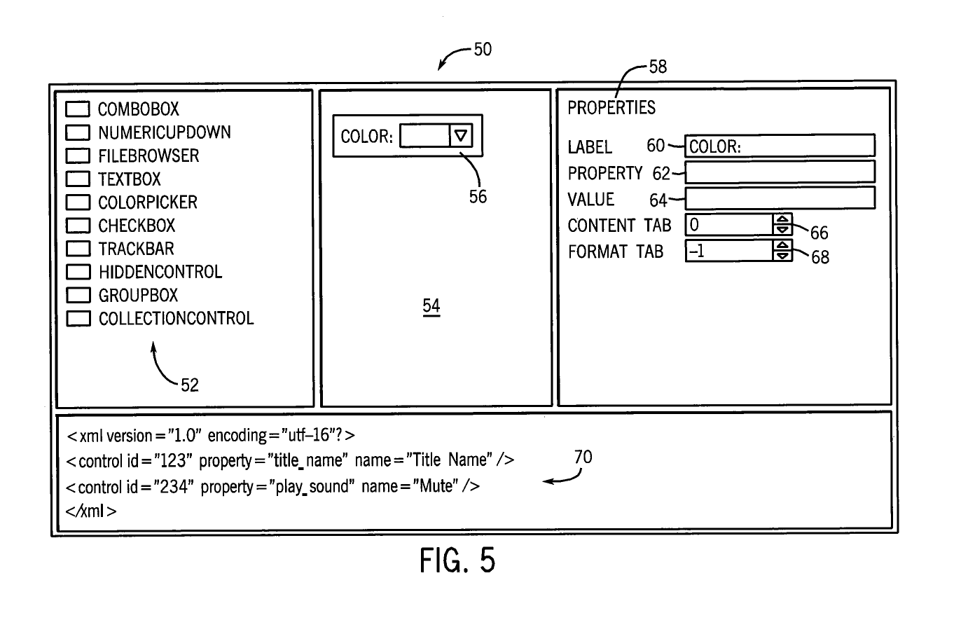

Turning to FIG. 5, user interface 50 of a software tool for specifying the content of component attribute file 48 is depicted. During preparation of component 40, the tool is used to generate component attribute file 48 that is then bundled with component application 42 in component 40. Using the tool, a listing of the component 40's adjustable attributes is defined. For each attribute, the tool is used to specify the control interface or preferred edit method for modifying the attribute, default values for the attribute, and other data related to the attribute.

The tool includes a listing 52 of available edit controls that are used to adjust one or more attributes of component 40. Any user interface that allows a user to modify a value may be defined as an available edit control. Listing 52 of controls include a file browser, text box, checkbox, track bar, and color picker. For each attribute of component 40, a suitable control is selected and dragged into content area 54. In FIG. 5, a color pick control 56 is added to content area 54. The color pick control 56 is used to adjust the color value of an attribute. The trackbar control provides a sliding scale for a user to select a number within a pre-defined range. The checkbox control provides a Boolean selection for a user to pick between one of two choices. The textbox control allows a user to enter or modify a text-based attribute of component 40. The filebrowser control allows a user to select a file that is then made available to component 40. After an appropriate attribute control 52 is selected and placed in content area 54, various properties 58 of control 52 are specified. Each control 52 is assigned label 60. Label 60 provides a human-readable label for the attribute. Property 62 contains the name of the attribute to be modified by the selected control 56. Value 64 defines a default value for the attribute. Numerical values 66 and 68 determine in what order controls 56 are displayed within the presentation editing software's interface.

As controls 52 are added to content area 54 and their properties 58 defined, the software tool generates and updates an extensible mark-up language (XML) record 70. XML record 70 encodes the listing of attributes, selected controls 56, and their properties 58 and is stored in component attribute file 48 with additional data relating to component 40.

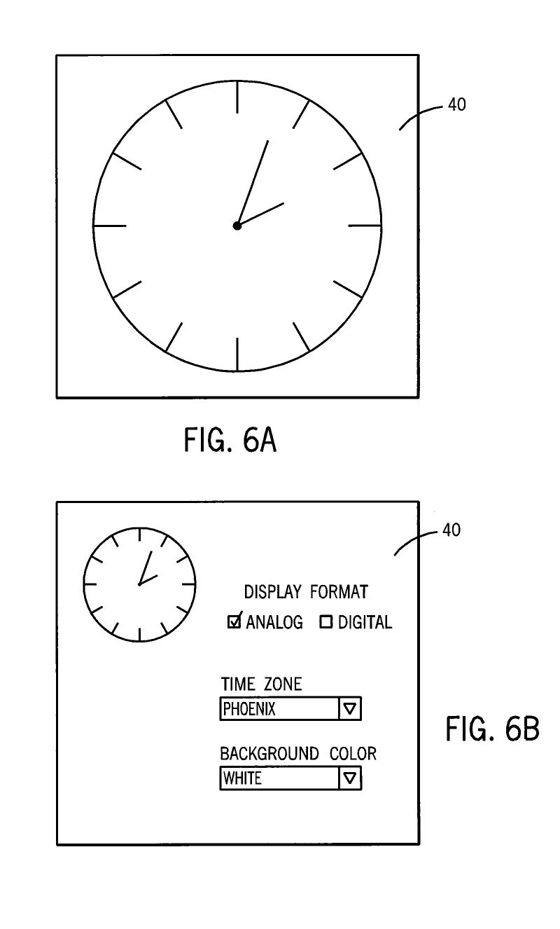

Returning to FIG. 4, while component 40 includes attributes whose values are modified using an external editor in communication with component attribute file 48, component 40 also includes attributes or variables that are modified directly through interfaces provided by component 40. These attributes are referred to as internal component attributes. To facilitate modification of the internal component attributes of component 40, component application 42 includes an edit mode. When component application 42 enters edit mode, it outputs a supplementary user interface for modifying its internal attributes. FIG. 6A shows a component 40 that displays a clock. The display format of the clock, the time zone and background color are internal component attributes. Upon entering edit mode, as shown in FIG. 6B, component application 42 adjusts the size of the clock and displays a toggle and additional select lists for a user to select whether the clock should be analog or digital, the clock's time zone, and the background color of the clock. As the users clicks on the inputs, component application 42 registers the user input and responds accordingly. For example, if the user selects an analog display mode, component application 42 first detects that the user clicked upon the analog display option, stores that data within component application 42, and updates the output accordingly. Upon exiting edit mode, component application 42 stops displaying the user interface and only displays the clock (as shown in FIG. 6A) using the configuration as specified by the user. Similarly, if component application 42 includes a text output, its edit mode may allow a user to highlight and edit portions of the text outputted by component 40. In another component 40 that displays simple shapes, upon entering edit mode, component application 42 displays grab or resize handles that allow a user to drag and modify the shape displayed by component 40. Because components 40 display varying content (and some don't display any content), edit mode for each component 40 includes a unique user interface. The addition of an edit mode for component application 42 allows a developer to include a unique user interface for modifying component 40. Any user interface can be included in component application 42's edit mode to allow a user to modify any aspect of component 40. Some components 40, however, contain minimal content and do not include an edit mode.

Component 40 contains assets 44 that include data used by component application 42. Assets 44 include binary and text-based data such as graphic, music or sound files, computer object code, fonts, effects, and computer scripts or other text files. If component application 42 displays images, for example, the associated image files are stored in that component 40's assets 44. Assets 44 of component 40 are stored as a plurality of data files combined into a single file such as an archive or zip file. Alternatively, assets 44 include a plurality of individual files that are made available to component application 42. Assets 44 or a subset of assets 44 may be stored upon a remote server or other data storage system made available to component application 42.

Component 40 includes IO API 46. IO API 46 provides a set of methods and/or classes that are incorporated into component application 42 and facilitate communication between component application 42 and an external system. IO API 46 includes one or more libraries containing computer scripts, programming code, or object code. Different libraries are made available for component application 42, external editing systems, and presentation viewers. Generally, each library includes similar functionality, however some different methods or functions are included depending upon the target system.

The methods provided by IO API 46 allow component 40 and the external systems to communicate strings of text and other data back and forth. The strings include text data encoded using delimited text strings. Binary data may include multimedia such as JPEG image files and AVI movie files. Using IO API 46, the communication of text strings or binary data is initiated by either component application 42 or the external system at any time.

IO API 46 includes functions used by the external system to instruct component 40 to initialize, or delete (dispose) of itself. Upon receiving a command to initialize, component application 42 retrieves its attribute values and runs accordingly. Upon receiving a delete instruction, component 40 performs any necessary clean-up and exits or deletes itself.

IO API 46 also enables the external system and component 40 to communicate data describing the component 40's current placement within a template of a presentation. Using IO API 46, the external system informs component 40 that it has been moved, resized, or rotated within the template. Upon receiving a notice that the dimensions or orientation of component 40 have been altered, component 40 adjusts its output in response to the new dimensions and orientation. IO API 46 similarly allows component 40 to communicate to the external system an update with component 40's new placement, rotation, size, depth or opacity.

IO API 46 enables commands including attribute updates and other instructions to be transmitted back and forth between component 40 and the external system. The commands take the form of text strings or arrays of text strings and include the name of a command and one or more command arguments. In some cases, commands are broadcast to all components 40 included within a single template. In one example, the external system uses IO API 46 to transmit a command to component 40 instructing it to update one or more attributes or execute a function or method made available by component 40. Similarly, component 40 uses IO API 46 to send commands to the external system instructing it to change the active template, hide another display element, transmit a command to other components 40, adjust the display characteristics of other display elements of the presentation, or exit the presentation.

IO API 46 also allows data files to be passed between the external system and component 40. Using IO API 46, the external system makes image, movie, and other multimedia data files available for consumption by component 40 for storing, playing, or modifying. When delivering data files to component 40, IO API 46 makes a file stream available which can be accessed by component 40 to retrieve the contents of the file. Alternatively, IO API 46 communicates a file path to component 40, which then retrieves the file. After retrieving the file, component 40 may store the file contents with assets 44. Similarly, component 40 uses IO API 46 to request that the external system make a file stream of a particular file available for consumption by component 40.

Component 40 uses IO API 46 to determine its current operating environment (for example, a run-time or edit environment) by accessing a state variable made available by the external system. The external system similarly uses IO API 46 to inform component 40 of its current operating environment. IO API 46 also includes functions that allow the external system to request that component 40 enter or exit its edit mode. If component application 42 of component 40 does not include an edit mode, it dismisses the request. Component 40 can similarly use IO API 46 to inform the external system that it is entering or exiting exit mode. In that case, the communication may take the form of a request asking the external system whether it is appropriate for component 40 to enter or exit its edit mode at the present time.

IO API 46 also includes functionality that allows the external system to request that component 40 play, pause, or rewind its content.

After component 40 is prepared, a single package is created that contains component application 42, assets 44, IO API 46, and component attribute file 48. The package includes a single file such as a zip or archive file, or a proprietary collection of files that contains all parts of component 40. Alternatively, the different parts of component 40 are stored separately such as on remotely accessible storage systems. For example, while component application 42, IO API 46, and component attribute file 48 are stored on a local desktop computer system, assets 44 are stored on a server accessible via network 46.

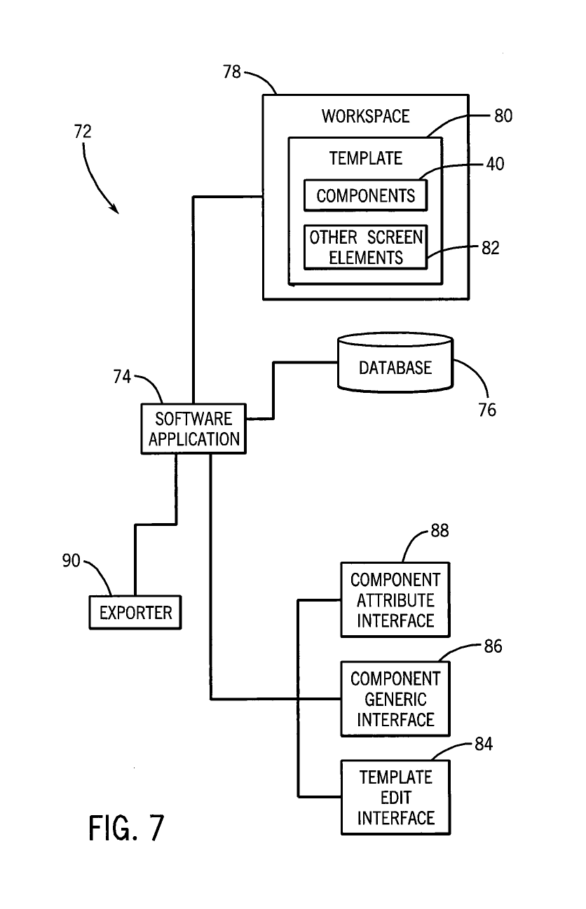

Presentation software editing system 72 is shown in FIG. 7. System 72 provides an interface for a user to prepare a presentation, modify the presentation's content and export a completed presentation for viewing. Using system 72, a user creates a new presentation, imports one or more presentation elements including components 40, templates and other display elements into the presentation, modifies their display attributes, and defines their inter-relationships. At any time, a user exports the presentation or a subset of the presentation for viewing.

System 72 includes core application 74. Core application 74 communicates with each part of system 72 and includes object code. Core application 74 displays an application window, visual data, and several on-screen widgets for user interaction. By interacting with the user interface provided by core application 74, a user creates a new presentation, imports and modifies the content of the presentation, and exports the presentation in a format for viewing.

To edit a presentation, the user first specifies which presentation is to be edited using an “open file” interface provided by core application 74. After the file containing the presentation is specified, core application 74 retrieves the file from database or file system 76 and reads its contents. The presentation file contains the contents of the presentation and includes a listing of a plurality of templates contained within the presentation, their contents including a listing of each component contained within each template, links to external files to be included within the presentation, and additional data that describe the presentation. If, however, the user instead wishes to create a new presentation, core application 74 generates a new, empty presentation file into which new content is inserted. If a presentation includes multimedia elements, the presentation file includes a reference or link containing the location of the multimedia file, for example by including a uniform resource locator (URL) or file path describing the location of the file. If a presentation includes a .JPEG image file, rather than include the content of the image file within the presentation file itself, the presentation file includes a file path describing the storage location for the image file. With that information, core application 74 can read the presentation file, retrieve the file path for the .JPEG file and retrieve the image contents. Alternatively, the multimedia data may be included within the presentation file itself. The presentation file also includes a reference to the files comprising any components 40 included within the presentation or may include the content of components 40 directly.

Having retrieved the contents of the presentation file, core application 74 designates a single template 80 of the presentation the active template and displays its contents for editing by a user. When first opening a presentation, the first template 80 of the presentation is designated the active template 80. However, a user may cycle through and edit the other templates 80 of the presentation using the interface provided by core application 74. During editing, active template 80 is displayed by the core application 74 within workspace 78.

Workspace 78 displays the active template 80 and its contents. Workspace 78 operates in its own window or frame that is defined by core application 74. In the present embodiment, core application 74 runs in an application window. Within that window, core application 74 defines a document window (also known as a frame, child window, or secondary window). Core application 74 then executes workspace 78 and the output of the workspace 78 program is displayed within that frame. An API is made available to allow core application 74 and workspace 78 to communicate commands and data back and forth. In alternative embodiments, however, the functionality of workspace 78 is incorporated within core application 74. Accordingly, workspace 78 and core application 74 may be prepared using the same programming language. In such an embodiment, an API is no longer necessary to facilitate communication between core application 74 and workspace 78.

To display the contents of active template 80, system 72 first retrieves active template 80 contents from the presentation file. The contents of template 80 include template 80's general attributes, a listing of components 40 contained within template 80, and a listing of other display elements 82 contained within template 80.

The general attributes of template 80 include a link to template 80's background images, associated sound effects, display timing attributes of template 80, and a listing of the sequencing of template 80 and the other templates of the presentation.

The listing of components contained within template 80 includes, for each component 40, an entry containing a unique identifier for the component such as an ID number or a file path describing the location of component 40, the value of any attributes defined by component 40, and the component's display size, placement, orientation, depth, and opacity within template 80. If the attributes of component 40 have not been altered by the user, the values for the attributes are generally the default values defined by component 40's component attribute file 48.

The listing of other display elements 82 for template 80 includes a listing of each display element in the template, and any display values associated with the display element. Other display elements 82 include, for example, images, movies or other multimedia, shapes, text, background images, and other pre-defined graphic and multimedia display elements that are added to template 80. Accordingly, if a template contains a circle element, the contents of template 80 include a listing for the circle screen element that includes its color, size, and placement within template 80. Similarly, if template 80 includes a text-box screen element, the contents of template 80 include a listing for the text-box element itself, and its content, placement, size, font, text-color, and background-color.

Having retrieved the contents of template 80, it is displayed by core application 74 via workspace 78. When displaying the contents of template 80, some of its content is created and displayed by core application 74 in combination with workspace 78. For example, core application 74 and workspace 78 include code for displaying template 80's general attributes and additional display elements 82. Accordingly, if a template includes a circle or square display element, core application 74 and workspace 78 contain code for drawing circle and square elements within workspace 78. Similarly, any attributes of a template 80, such as background images or sound effects, are prepared and played or displayed by core application 74 in combination with workspace 78.

Unlike the pre-defined general attributes and general display elements 82 of template 80, core application 74 and workspace 78 do not, by themselves, display the content of component 40. Instead, system 72 relies upon component application 42 to generate and output the content and implement the functionality of component 40. To display the output of component 40 within workspace 78, core application 74 first retrieves general display information for component 40 including its placement location, size, orientation, depth, and opacity from the listing of template 80 contents within the presentation file. The general display information for component 40 is communicated to workspace 78. Core application 74 issues an initialized command to component 40 via IO API 46 to create a new instance of component 40. As part of the initialization process, core application 74 retrieves the current attribute values for component 40 from the presentation file and transmits those values to component 40 using IO API 46. If component 40 is inserted into the presentation for the first time, core application 74 retrieves component 40's default values from component attribute file 48 and transmits those values to component 40 via IO API 46. Component 40 updates its internal listing of attributes with the new values provided by core application 74. After component 40 is initialized and generates output (including visual and sound output) the output is communicated to workspace 78. Workspace 78 then displays component 40's output within its general display parameters, such as placement location, size, rotation and opacity, as defined by the presentation file. At this time, component 40 is placed into an edit environment.

With template 80 and its contents displayed via workspace 78, the user interacts with workspace 78 to edit template 80, and template 80's contents. To manipulate template 80's general attributes or additional display elements, a template edit interface 84 is provided by core application 74 and workspace 78. The template edit interface 84 allows a user to change the background image for template 80, adjust the display timing of template 80, and add sounds effects for template 80. Additional user interfaces are provided to allow a user to edit the additional display elements 82 such as shapes, text, and icons. An interface is provided to change the content of text boxes, adjust the color of any shapes added to the presentation, and alter images or multimedia display elements that are inserted into template 80.

To manipulate components 40 included within template 80, however, several additional user interfaces are provided. First core application 74 provides a component generic interface 86, to control a component 40's size, placement, orientation, depth, and opacity of component 40 within workspace 78. Component generic interface 86 includes grab handles at the perimeter of component 40 for adjusting the size and orientation of component 40. The user clicks on and drags component 40 to alter its placement. The opacity and depth of component 40 are adjusted by first selecting component 40 and then adjusting its opacity or depth via a data-entry field. Upon adjusting the size, placement, orientation, or opacity of component 40, the updated general display information is communicated to component 40 by core application 74 using IO API 46. Because a component 40's size, placement, orientation, depth, and opacity may not be controlled by component 40 and are instead controlled and defined by core application 74 and workspace 78, the user interface for adjusting those attributes of component 40 are provided by core application 74 and workspace 78 directly, rather than by component 40. In an alternative embodiment, however, component 40 directly provides the interface for controlling component 40's size, placement, orientation, depth, and opacity.

Component generic interface 86 further allows a user to define how component 40 interacts with other elements of a presentation, including other components 40, templates 80, and display elements 82. For each display element, the interface allows a user to specify an event. Possible events include user inputs such as mouse clicks, mouse overs, mouse drags, and key strokes, or other events such as timing events. For each event, the user specifies an action to perform should the event occur. Actions include changing the active template of the presentation, making other display elements disappear or appear, exiting the presentation, or broadcasting a command to all components 40 displayed on the active template 80.

As an example, the component generic interface 86 allows a user to define an ‘on-click’ attribute for a component 40. Using the on-click attribute, a user configures component 40 so that when a user clicks on component 40, the presentation displays a different template 80 and alters the display attributes of another component 40. Component generic interface 86 allows for similar functionality to be defined for other non-component based elements of a presentation, such as text boxes, buttons, images, and shapes.

If one or more components 40 of the presentation define available functions within their component attribute files 48, core application 74 retrieves that listing of available functions and includes within component generic interface 86 an interface for specifying a relationship between one or more components 40 and/or other display elements 82 and those functions. The interface includes a list of all available functions within the presentation or template 80, inputs for defining the arguments associated with the function, and an action for initiating execution of the function. Actions include mouse-clicks, mouse-overs, keystrokes or other user input or other events as described above. For example, a component 40 within the presentation or template includes a ‘play_animation’ function. After selecting another component 40 or display element 82, component generic interface 86 for the selected component 40 or display element 82 includes an interface for specifying that, in response to an action performed on the selected component 40 or display element 82, component 40 execute its ‘play_animation’ function. A user specifies that upon clicking a button display element 82, core application 74 transmits a message to component 40 using IO API 46 instructing it to execute its ‘play_animation’ function.

Component generic interface 86 also allows a user to define display timing attributes for each component 40. Display timing attributes define time periods during which a component 40 is either displayed or hidden within template 80 during the presentation. In addition to display timing, a user uses the interface to associate effects with component 40 to control its display style. For example, component generic interface 86 is used to specify that a component 40 should appear within template 80 10 seconds after the template 80 is first displayed, and then disappear by sliding off an edge of template 80 after 20 seconds. Additional effects include making component 40 fade in and out of the presentation, sliding it from the screen in any direction, and the like. A component 40's depth within template 80 is also defined using component generic interface 86. A component 40's depth value, when compared to the depth value for another component 40 or display element 82, specifies which component 40 or display element 82 is displayed over the other. Accordingly, the depth of component 40 is used to send component 40 towards the background or foreground of a presentation.

Core application 74 also provides component attribute interface 88. Component attribute interface 88 allows a user to modify the attributes of component 40. To display component attribute interface 88, core application 74 first retrieves component attribute file 48 for the selected component 40. Component attribute file 48 contains a listing of a component 40's attributes, defines default values for those attributes, and specifies a preferred edit method of each attribute. After a user selects a component 40 within template 80 and workspace 78, core application 74 inspects the listing of attributes contained within component attribute file 48 for that component 40 and displays the appropriate edit interface for each attribute. The user then modifies the attributes of component 40 using component attribute interface 88. The new attribute values are communicated to component 40 by core application 74 using IO API 46. Component 40 updates its own internal attribute listing of attributes with the new values and updates its display.

A user modifies component 40's internal component attributes via component 40's edit mode. To access component 40's edit mode, for example, a user double-clicks upon component 40 within workspace 78. Workspace 78 and core application 74 detect that the user double-clicked, determines over which component 40 the user double-clicked, and then sends a command to component 40 requesting that component 40 enter its edit mode. If component 40 includes an edit mode, component 40 executes the edit mode for component 40. Having entered edit mode, a user clicks on and interacts directly with component 40's edit mode. In the present embodiment, the use interacts directly with component 40. However, in alternative embodiments, all user input events are first captured by workspace 78, which then communicates the events to component 40.

Core application 74 includes exporter 90 for exporting a presentation or a subset of a presentation. Exporter 90 generates a single output file or collection of files that can be viewed independently of presentation software editing system 72—for example, on another computer system. The output file includes the data contained within the presentation file and additional data or files that are referenced within the presentation file. Accordingly, the output file includes a listing of all templates 80 contained within the presentation and their inter-relationships, all components 40 contained within each template 80 and their inter-relationships, and all other display elements 82 and their inter-relationships. The output file includes a listing of general attributes for each template 80 of the presentation such as any background images and sound effects. The output file includes a listing of display timing attributes for each template 80, component 40, and other display elements 82, if specified. Each timing attribute also specifies effects including sound or visual effects associated with the appearance or disappearance of template 80, component 40 and other display elements 82. Finally, the output file includes multimedia data, components 40, and additional data files that are included within the presentation. The additional data files include fonts, effects, computer object code, and computer scripts or other text files.

If the output file is to be played on computer 24, computers 38 or 40, or another PC-based computer system, the output file includes a run-time engine for playing the content of the presentation. The run-time engine retrieves the contents of the presentation file and displays the contents accordingly. In one embodiment, the run-time engine is a flash-based program that is executed by the viewing computer. The run-time engine includes code for reading the contents of the output file, displaying the non-component elements of the presentation, communicating with each component 40 of the presentation, capturing user input, capturing the output of the components 40, and displaying that output. The output of the components 40 include visual data, sound and any other output of component application 42.

Upon execution, the run-time engine displays a frame or window in which the presentation is displayed. The run-time engine also retrieves a listing of templates 80 contained within the output file and determines the first template 80 of the presentation. The run-time engine retrieves the contents of template 80 and additional multimedia or component 40 files or data included within template 80 from the output file. The run-time engine displays the non-component based content of template 80 including background images, sound effects, text boxes, shapes, and additional multimedia within the display window. The run-time engine also issues initialized commands to each component 40 included within template 80 via IO API 46. At that time, the current operating environment for each component 40 is set to a ‘run-time environment’ and the attribute values for each component 40 contained within the output file are communicated to each component 40. The output of each component 40, including visual and sound output, is captured by the run-time engine and displayed in accordance with the component 40's general display attributes, such as placement location, size, orientation, depth, and opacity, contained within the output file. At this time, any display timing attributes and effects associated with the display of any elements of template 80 are implemented by the run-time engine.

Having displayed template 80 and its contents via the display window, the viewer interacts with the run-time engine and components 40 and display elements 82 of template 80 to view the presentation. For example, the viewer may click on one or more components 40 or other display elements 82 to view animations, hear sound effects, or reveal additional content. Also, the viewer controls the flow and pace of the presentation by interacting with the run-time engine. To facilitate viewer control of the presentation, the run-time engine captures all viewer input, determines with which screen element the viewer interacted, and responds. If the run-time engine detects that a viewer has clicked on the presentation, the run-time engine first determines whether the viewer clicked on any of the display elements 82 or components 40 displayed in template 80. If the viewer clicked on a display element, such as a component 40 or an image, shape, or button, the run-time engine inspects the output file to determine whether the display element includes functionality that responds to a mouse click. If so, the run-time engine executes the associated functionality, for example, by making the element disappear, changing the active template 80 of the presentation, sending a command to a component 40, or broadcasting a command to more than one component 40. If the run-time engine determines that the viewer clicked on component 40, the run-time engine also passes the viewer input data to component 40 using IO API 46. The viewer input data includes the location of a mouse-click within the presentation window, which button was clicked, whether the mouse-click includes a click-and-drag action, and other viewer input data such as simultaneous keystrokes. Having received the viewer input data, component 40 uses its current placement location, size, and rotation data, retrieved via IO API 46, to determine where within component 40 the mouse-click occurred. Alternatively, the run-time engine uses the current placement location, size, and rotation data of component 40 to determine the location of a mouse-click within component 40 and passes the location to component 40. After receiving the viewer input data, component 40 executes its response. An example response may include displaying an animation in response to a mouse-click, or adjusting the component 40's output in response to a click-and-drag action.

While the presentation is displayed, the run-time engine mediates communication between components 40 within active template 80. The communications may be between specific components 40, or may take the form of broadcast messages that are communicated to all components 40 displayed within the current template 80. Using IO API 46, the run-time engine captures communications initiated by a component 40 within template 80 and transmits the communications to one or more components 40 within template 80. An example component 40 includes functionality that, when a viewer clicks on the component, issues a command to the run-time engine via IO API 46 requesting that the engine broadcast a command to all components 40 displayed within template 80 instructing them to execute a particular function, such as a ‘hide_display’ function. If the receiving component 40 includes such a function, it executes that function. If the receiving component 40 doesn't include the function, it ignores the request. By allowing the run-time engine to mediate the communication of commands and messages between all components 40 of a presentation, each component 40, although produced independently of the other components 40 in the presentation can interact with other components 40 of a presentation.

During export of the presentation, the output file is manipulated to tailor it to the system used to view the presentation. The output file may include a movie file that, when viewed, displays each template of the presentation in a pre-determined sequence with a time duration for each template. When playing as a movie, a viewer cannot interact with the presentation. If the presentation is exported as a movie for viewing on a digital device having a relatively small screen (such as a personal digital assistant (PDA) or cell phone), the dimensions of the movie file and its relative file size are minimized to facilitate viewing of the file on the device.

In an alternative embodiment, the output file is configured to allow the presentation to be displayed on a website. In that case, the system exports an output file or combination of files that are consumable by web browsers or other web-enabled applications. Accordingly, after it is exported, the user uploads the output file or collection of files to a web-server for distribution of the presentation via the Internet.

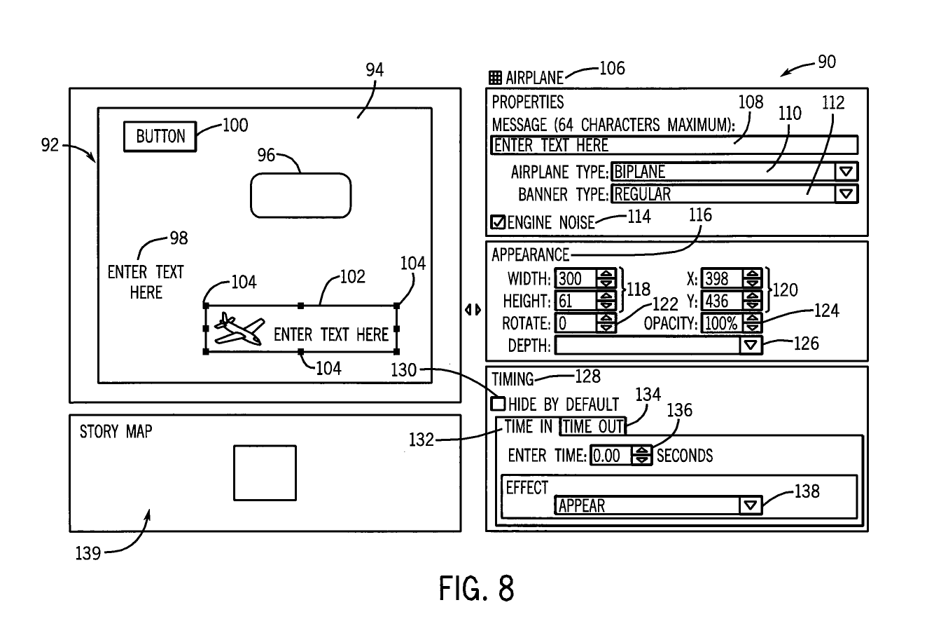

Turning to FIG. 8, an exemplary user interface 90 for presentation software editing system 72 is shown. Interface 90 includes workspace 92 that displays template 94 and its contents. Template 94 includes a rectangle screen element 96, a text screen element 98, a button screen element 100, and a component 102. Component 102 outputs an animated image, outputs sound effects and includes a text display. Around the perimeter of component 102, core application 74 displays grab handles 104 for resizing, rotating and moving component 102 within template 94. By double-clicking on component 102, component 102 enters its edit mode which allows a user to directly highlight and modify the text displayed by component 102.

Component attribute interface 106 allows a user to adjust the attributes of component 102 (the currently selected screen element within template 94). Component attribute interface 106 includes a listing of those attributes defined within the component 102's component attribute file 48. Here, attributes of component 102 include message 108, airplane type 110, banner type 112, and engine noise 114 attributes. In this case, the message associated with component 102 can be altered by component 102's edit mode, or component attribute interface 106. For each attribute, component attribute interface 106 includes the preferred edit method for each attribute. For message 108, the preferred edit method includes a text box having a character maximum. For airplane type 110 and banner type 112, the edit method includes select lists that allow a user to pick from a list of available airplane types 110 and banner types 112. Finally, the preferred edit method for engine noise 114 is a checkbox. The engine noise attribute determines whether component 102 plays a sound effect while in a run-time operating environment.

Interface 90 includes a component generic interface 116, to control component 102's size 118, placement location 120, orientation 122, opacity 124 and depth 126. A similar interface is provided to adjust the size, placement, orientation, opacity and depth of non-component display elements within template 94 such as rectangle 96, text box 98, and button 100.

Interface 90 further includes a timing interface 128 for adjusting when a particular element of the presentation appears and disappears. Timing interface 128 allows a user to specify at what point in time the selected element is displayed within the presentation and to specify effects associated with the appearance and disappearance of the display element. Checkbox 130 allows a user to specify whether the selected display element is hidden by default. Time-in tab 132 and time-out tab 134 allow a user to select a time duration 136 for when display elements appear and disappear. Finally, select box 138 allows a user to select the effect associated with the appearance or disappearance of the selected display element.

Map 139 shows the templates 80 of the presentation and their display order. Using map 139 a user adjusts the order in which templates 80 are presented by clicking on and dragging the images of templates 80 within map 139. Map 139 also allows a user to select multiple templates 80 and combine them into a single chapter. After defining a chapter, all templates 80 contained within the chapter are removed from map 139 and replaced by a single chapter icon. For a presentation that includes many templates 80, chapters simplify the depiction of the presentation flow within map 139. When exporting the presentation, exporter 90 exports the entire presentation, one or more chapters of the presentation, or a combination of chapters and templates 80 contained within the presentation.

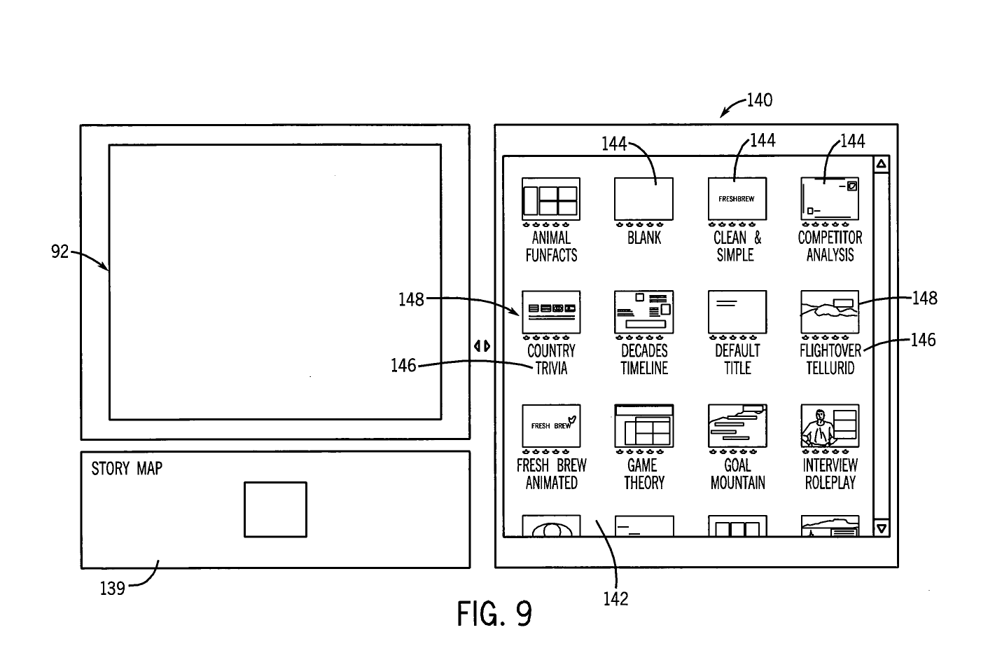

Turning to FIG. 9, a second exemplary user interface 140 for presentation software editing system 72 is shown. Interface 140 includes library window 142. Library window 142 displays a plurality of presentation elements 144 that can be added to workspace 92. Presentation elements 144 include templates 80 and components 40. Presentation elements 144 are selected from within library window 142 and then inserted into workspace 92 or map 139. By inserting a template 80 into map 139, a user can place the template into a particular point within the sequence of the presentation. Each template 80 in library window 142 can include pre-made content. The pre-made content can include multiple components 40, or other display elements such as text boxes, shapes, or other buttons placed within template 80. For each presentation element 144 in library window 142, library window 142 includes a title 146 and a thumbnail image 148. Thumbnail image 148 includes a small image providing a preview of the presentation element 144 contents. The preview may be static, or depict the animated content of presentation element 144.

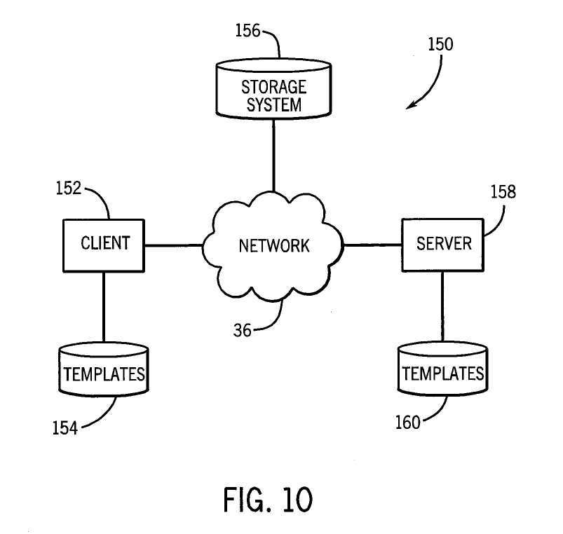

Turning to FIG. 10, a community system 150 for distributing pre-made templates 80 amongst a plurality of users of the presentation software system 10 is depicted. A client computer 152 runs system 10 and accesses templates 80 via local template database 154. Local template database 154 includes a data storage system located proximate to and accessible by client computer 152 such as a local hard drive or solid-state storage system or a storage system available via a network such as network accessible storage system 156. While using system 10, a user causes client computer 152 to access local template database 154 to retrieve templates 80 for addition to a presentation, or to alter the content of templates 80.

Depending upon the presentation, however, a user may wish to incorporate templates prepared by other users. In that case, client computer 152 communicates with server 158 via network 36 to retrieve additional templates 80.

Server 158 includes a computer system capable of communicating via electronic network 36. Server 158 includes template database 160. Template database 160 is a database system for storing and retrieving templates and their associated code, components and display elements such as an Oracle, PostgreSQL, mySQL, or Microsoft SQL database system. In alternative systems, server 158 stores templates 80 on an accessible file system. Server 158 also provides an interface for communicating with client computer 152 via network 36. For example, server 158 includes a web server such as Apache or Microsoft Internet Information Services capable of running code stored within server 158 to provide a web-based user interface. Server 158 receives communications from client computer 152 and, in response, transmits web-pages to the client computer 152 via network 36. The web pages include computer code or mark-up language and/or additional content such as images, sounds, and/or video. In response to a request from client computer 152 for a particular web-page, server 158 transmits a web-page including text, graphics, and flash animations to client computer 152 via network 36.

To retrieve and import additional templates into local template database 154 and/or a presentation, client computer 152 accesses a search interface provided by server 158. In the present embodiment, the search interface includes a web-page providing a plurality of search options. For example, the search interface allows for searching by template name, description, file size, author, upload date, or cost. To initiate a search, client computer 152 submits its search criteria via the search interface. The results of the search are then transmitted to client computer 152 via network 36 by server 158. If the search results include a template that the user of client computer 152 wishes to retrieve, the user uses the web page containing the search results to initiate download of the template and its contents via network 36 by transmitting a download request to server 158. After receiving the download request, server 158 retrieves the template and its contents (including code, components, text, graphics, sound and any other data associated with the template) from template database 160 and transmits the data to client computer 152. After receiving the template and its contents, client computer 152 stores the data within local template database 154 or network accessible storage system 156. After retrieving and storing the template, the user incorporates the template into a presentation using system 10.

The community system depicted in FIG. 10 facilitates the distribution of templates and their contents between a plurality of users. In alternative embodiments, the community system also provides for the distribution of themes, components 40, stories or other elements of a presentation. In one embodiment, a user must first authenticate with server 158 before accessing the community templates via network 36. The authentication requires that the client computer 152 transmit a username and password to server 158 before searching or retrieving templates. The authentication process also requires that the user pay a fee before accessing the templates. In an alternative embodiment, however, the templates are free to search and a fee must be paid before any single template is retrieved. In that case, the price of all templates may be identical, or varied depending upon one or more template attributes. For example, the price of a template may vary depending upon its popularity, author, size, or commercial appeal. Authors are free to upload templates to the community site via server 158. At that time, the authors specify their preferred price to be paid before the template is downloaded.

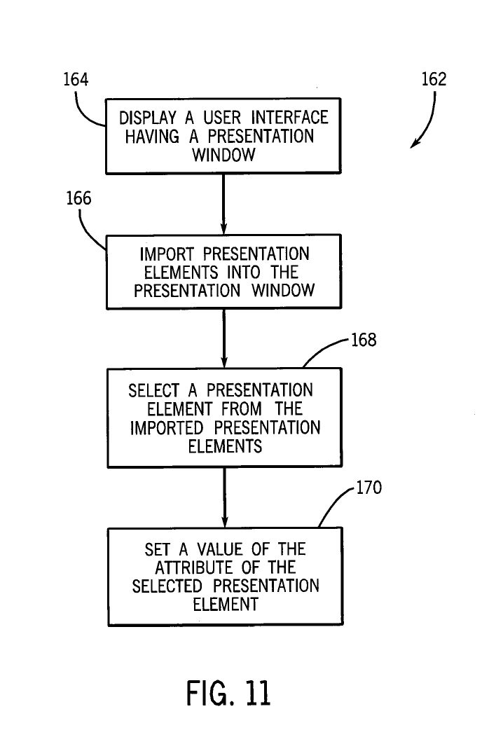

FIG. 11 illustrates the steps involved in generating a presentation. In step 164, a user interface is displayed by the presentation software application. The user interface includes a presentation window or workspace that allows a user to create and import the contents of the presentation. In step 166, presentation elements are imported into the presentation window. The presentation elements include templates and/or components. In one embodiment, a listing of available presentation elements is displayed within a library window. For each component or template, the library window includes a thumbnail image and a title. Each of the presentation elements has an attribute that defines a logical relationship with another presentation element. In step 168, a presentation element is selected from the imported presentation elements. In step 170, a value of the attribute of the selected presentation element is set to logically relate the imported plurality of presentation elements to create the presentation. The logical relationship of the various presentation elements modifies the output of the presentation. For example, the logical relationships may define an alternate path through the presentation content. Each presentation element or the presentation itself outputs a user interface for executing the logical relationship.

In one embodiment, a method for providing a display component includes providing a component application having an attribute. The component application is configured to communicate with an external system. A value of the attribute of the display component is modified to define a logical relationship between a plurality of presentation elements. The presentation elements are operated and displayed by the external system. A user input is received via a user interface of the component application. The logical relationship between the presentation elements is triggered in response to the user input. In one embodiment, triggering the logical relationship includes defining an alternate path through a presentation.

The presentation software system and display components described above offer a number of advantages. A user can quickly prepare presentations that incorporate sophisticated display elements without first having to develop a thorough understanding of computer programming or graphic design. Also, when viewed, the presentation allows for user interaction and, accordingly, maintains a viewer's attention throughout the presentation.

While one or more embodiments of the present invention have been illustrated in detail, the skilled artisan will appreciate that modifications and adaptations to those embodiments may be made without departing from the scope of the present invention as set forth in the following claims.

What is claimed is:

1. A computer-implemented method of providing a display component, comprising:
providing a component application having an attribute, the component application being configured to communicate with an external system;
modifying a value of the attribute of the display component to define a logical relationship between a plurality of presentation elements, the presentation elements being operated and displayed by the external system;
receiving a user input via a user interface of the component application; and
triggering the logical relationship in response to the user input.

2. The method of claim 1, including receiving a communication from the external system to modify the value of the attribute.

3. The method of claim 1, wherein triggering the logical relationship in response to the user input includes defining an alternate path through a presentation.

4. The method of claim 1, including providing a display component attribute file defining a plurality of attributes of the display component and values of the plurality of attributes.

5. The method of claim 1, including providing an edit mode user interface for modifying a value of an internal display component attribute.

6. The method of claim 1, including communicating a command to the external system.

7. The method of claim 6, wherein the command causes the external system to modify an attribute of another display component.

8. The method of claim 1, including accessing a file stream made available by the external system.

9. A computer-implemented method of providing a display component, comprising:
providing a component application having an attribute;
modifying a value of the attribute of the display component to define a logical relationship between a plurality of presentation elements, the presentation elements being operated and displayed by an external system;
receiving a user input via a user interface of the component application; and
triggering the logical relationship between the plurality of presentation elements in response to the user input.

10. The method of claim 9, including receiving a communication from the external system to modify the value of the attribute.

11. The method of claim 9, wherein triggering the logical relationship in response to the user input includes defining an alternate path through a presentation.

12. The method of claim 9, including providing a display component attribute file defining a plurality of attributes of the display component and values of the plurality of attributes.

13. The method of claim 9, including providing an edit mode user interface for modifying a value of an internal display component attribute.

14. The method of claim 9, including communicating a command to the external system.

15. The method of claim 14, wherein the command causes the external system to modify an attribute of another display component.

16. The method of claim 9, including accessing a file stream made available by the external system.

17. A computer program product usable with a programmable computer processor having a computer readable program code embodied therein, comprising:
computer readable program code which provides a component application having an attribute, the component application being configured to communicate with an external system;
computer readable program code which modifies a value of the attribute of the display component to define a logical relationship between a plurality of presentation elements, the presentation elements being operated and displayed by the external system;
computer readable program code which receives a user input via a user interface of the component application; and
computer readable program code which triggers the logical relationship in response to the user input.

18. The computer program product of claim 17, including computer readable program code which receives a communication from the external system to modify the value of the attribute.

19. The computer program product of claim 17, wherein the computer readable program code which triggers the logical relationship in response to the user input includes computer readable program code which defines an alternate path through a presentation.

20. The computer program product of claim 17, including computer readable program code which provides a display component attribute file defining a plurality of attributes of the display component and values of the plurality of attributes.

21. A computer system for providing a display component, comprising:
means for providing a component application having an attribute, the component application being configured to communicate with an external system;
means for modifying a value of the attribute of the display component to define a logical relationship between a plurality of presentation elements, the presentation elements being operated and displayed by the external system;
means for receiving a user input via a user interface of the component application; and
means for triggering the logical relationship in response to the user input.

22. The computer system of claim 21, including means for receiving a communication from the external system to modify the value of the attribute.

23. The computer system of claim 21, wherein the means for triggering the logical relationship in response to the user input includes means for defining an alternate path through a presentation.

24. The computer system of claim 21, including means for providing a display component attribute file defining a plurality of attributes of the display component and values of the plurality of attributes.

25. The computer system of claim 21, including means for providing an edit mode user interface for modifying a value of an internal display component attribute.
